(19) United States
(12) Patent Application Publication
(10) Pub. No.: US 2001/0037261 A1
(43) Pub. Date: Nov. 1, 2001

(54) Agent purchase method, agent purchase system and record medium containing transaction management program

(75) Inventor: Seiichi Ishitsuka, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/840,139

(22) Filed: Apr. 24, 2001

(30) Foreign Application Priority Data
Apr. 27, 2000 (JP) 2000-128013

(51) Int. Cl. G06F 17/60

(52) U.S. Cl. 705/26

(57) ABSTRACT

This agent purchase method for agent purchase via communication lines comprises a step which, by receiving from the user terminal the specification of the purchased merchandise and the specification of the seller selling the merchandise via communication lines as the supplier of the merchandise, accepts the request for agent purchase of the merchandise, a step to refer to or update the credit level record of the seller for transactions, a step to purchase the merchandise requested for agent purchase from the seller and deliver that merchandise to the user and a step to manage charging for the agent purchase service provided to the user.

### BACKGROUNDS OF THE INVENTION

1. Field of the Invention

The present invention relates to an electronic commerce system and in particular relates to an agent purchase method and an agent purchase system therefor to provide the agent purchase service via electronic commerce and a record medium containing a transaction management program.

2. Description of the Related Art

Recently, the electronic commerce systems such as online shopping where the merchandise is sold and purchased on network via communication lines are widely utilized. Online shopping is made via various communication lines including Internet, PC networks and cable TV networks and the users of such systems can access the communication lines and order merchandises by using information processing terminals such as desktop and notebook PCs or portable phones, PHS (personal handy phone systems) or other communication terminals capable of text data transmission such as those using the i-mode system.

The seller of the merchandise can register pages or the like to sell the merchandise on communication lines and can receive orders from users through a page for order placing or through e-mails.

Thus, the online shopping enables the user to order the merchandise via communication lines at any time from home or from any other place where the user is without visiting the shop where the merchandise is sold. The seller of the merchandise can receive orders for the merchandise just by preparing the page for accepting orders for the merchandise and can save expensive investments into the shop and parking lot for selling the merchandise.

Conventionally, payment in the online shopping has been settled by credit card or bank transfer systems. Thus, in the online shopping, the merchandise and the price for it are not directly exchanged, and the seller and the buyer do not directly meet each other for transactions.

Further, the user may enjoy the so-called “agent purchase service” to have an agent purchase and deliver the merchandise for the user. In the agent purchase service, the agent accepts requests for purchase of the merchandise via telephone, facsimile or the like, purchases and delivers the requested merchandise and receives the payment for the agent purchase service together with the payment for the merchandise.

In addition, conventional technologies to intermediate the electronic commerce include the prior art disclosed in the Japanese Patent Application Laid-open Prints No. 2000-36000 and No. 11-353382.

The prior art disclosed in the Japanese Patent Application Laid-open Print No. 2000-36000 proposes the technology to have a third party certify the parties of a transaction in electronic commerce and keep the record about the transaction agreement so that the agreement contents of the transaction can be evidenced.

The prior art disclosed in the Japanese Patent Application Laid-open Print No. 11-353382 proposes the technology to prevent abuse of the user's credit card number informed to the seller in the electronic commerce. According to this technology, the agent service for the settlement procedures in the electronic commerce is provided so that the agent follows the purchase procedures using its own credit card No. for the user and then collects the purchase price and the service fee from the user.

However, there are drawbacks as follows in the conventional electronic commerce including online shopping and the agent purchase system.

Firstly, in the conventional online shopping system, the user cannot sufficiently check the seller. Problems such as no delivery of the merchandise though the user has paid the price for it or no payment though the merchandise has been delivered have often occurred.

Conventional technologies to solve this problem include the certification system which certifies that the merchandise seller and the merchandise are surely the company and the merchandise shown on the web page. This system, however, is an identification system applicable to those officially registered to the certification organization for such organization only, and the sellers which can be verified by this system are quite limited. Therefore, a system in which the user can judge the credit of the merchandize seller (or the merchandise buyer and the individual seller who is not a corporation) on communication lines on the basis of the transaction results so far has been requested.

Secondly, in the conventional agent purchase service, the system is not automated. Acceptance of requests, purchase of merchandises, service fee charging and all other works are processed manually and quite inefficiently. Further, except for the merchandise requested for periodic purchase in advance, the user of the agent purchase needs to explain the request contents in details using telephone and facsimile for every request. This gives the user a lot of trouble.

According to the prior art disclosed in the Japanese Patent Application Laid-open Print No. 2000-36000, it is necessary that all parties of the electronic commerce transaction have been registered to the system in advance. Further, the object of this system is to certify the agreement contents of the electronic commerce transaction and is not to purchase the merchandise for the user.

The object of the prior art disclosed in the Japanese Patent Application Laid-open Print No. 11-353382 is to purchase the merchandise without informing the seller of the credit card No. of the person who places the order. This system can avoid a risk in the electronic commerce about this point. However, this cannot avoid the major and more often occurring trouble in the electronic commerce: no delivery of the merchandise due to the seller's illegal conduct or the like. In such case, the ordering person should bear the damage and the risk of transaction is not eliminated. Further, difference between the destination (ordering person) of the delivery from the seller and the direct price payer (agent) makes the settlement of such trouble difficult. Besides, many ordering persons do not want to inform the seller to the network of their addresses and names in addition to their credit card Nos. However, because the seller arranges the merchandise delivery to the ordering person, the private information about the ordering person cannot be hidden from the seller.

### SUMMARY OF THE INVENTION

A first object of the present invention is to solve the above drawbacks of the prior art and to provide an agent purchase method and an agent purchase system therefor and a record medium containing a transaction management program for online shopping or the like with which the credit of the other party of the transaction is judged based on the transaction results so far and the purchase of the merchandise the user wants to purchase is executed by an agent so that troubles in the electronic commerce including the risk of transaction failure and the abuse risk of the private information can be avoided and safe electronic commerce services can be achieved.

A second object of the present invention is to solve the above drawbacks of the prior art and to provide an agent purchase method and an agent purchase system therefor and a record medium containing a transaction management program to process many of the procedures in the conventional agent purchase service automatically and achieve an efficient agent purchase service.

A third object of the present invention is to solve the above drawbacks of the prior art and to provide an agent purchase method and an agent purchase system therefor and a record medium containing a transaction management program which enables specification of the purchased merchandise and the supplier without troublesome explanation or procedures so that the agent purchase can be requested with easy operations.

According to the first aspect of the invention, an agent purchase method for agent purchase via communication lines comprises

a step which, by receiving from the user terminal the specification of the purchased merchandise and the specification of the seller selling the merchandise via communication lines as the supplier of the merchandise, accepts the request for agent purchase of the merchandise;

a step to refer to or update the credit level record of the seller for transactions;

a step to purchase the merchandise requested for agent purchase from the seller and to deliver the merchandise to the user and

a step to manage charging for the agent purchase service provided to the user.

In the preferred construction, the credit level information about each of the sellers selling the merchandise via communication lines is recorded in the database and

the database is searched for the credit level record of the seller specified as the supplier of the merchandise so that the requested agent purchase is executed only when a sufficiently good credit level is recorded.

In another preferred construction, used for provision of the agent purchase service to the users of the Internet connection service rendered by an Internet provider.

In another preferred construction, the agent purchase is requested

with specification of the seller by specifying the address of the Internet web page of the seller.

In another preferred construction, used for provision of the agent purchase service to the users of the Internet connection service by an Internet provider wherein:

the Internet provider charges the users of the Internet connection service to pay the utilization fee of the agent purchase service together with the fee of the Internet connection service and collects these fees together.

In another preferred construction, used for provision of the agent purchase service to the users of the Internet connection service by an Internet provider wherein:

the agent purchase service is requested

with specification of the seller by specifying the address of the Internet web page of the seller and

the Internet provider charges the users of the Internet connection service to pay the utilization fee of the agent purchase service together with the fee of the Internet connection service and collects these fees together.

In another preferred construction, the agent purchase method further comprises

a step to classify the sellers from which the agent purchase is available by the category of the merchandise to be sold and to record such list and

a step to search the list for the seller selling the merchandise requested for agent purchase from the user.

In another preferred construction, the agent purchase method further comprises

a step to record the credit level information for each of the sellers selling the merchandise via communication lines to a database,

to search the database for the credit level record of the seller specified as the supplier of the merchandise and to execute the requested agent purchase only when a sufficiently good credit level is recorded,

a step to classify the sellers from which the agent purchase is available by the category of the merchandise to be sold and to record such list and

a step to search the list for the seller selling the merchandise requested for agent purchase from the user.

In another preferred construction, the agent purchase method further comprises

a step to search the communication lines for the seller selling the merchandise requested for agent purchase from the user,

a step to investigate the transaction credit level of the seller selling the applicable merchandise hit by the search and

a step to execute the agent purchase from the applicable seller when the seller hit by the search has a sufficient credit level.

In another preferred construction, the agent purchase method further comprises

a step to register the sellers selling the merchandise and

a step to make the information about the merchandises sold by the registered sellers public on communication lines.

In another preferred construction, the fee of the agent purchase service for the merchandise sold by the registered seller is charged to the applicable seller.

According to the second aspect of the invention, an agent purchase method for agent purchasing via communication lines comprises

a step to register the sellers selling the merchandise,

a step to open the information about the merchandise sold by the registered sellers on communication lines,

a step to receive request for selling of the merchandise the user desires to purchase from the user terminal,

a step to deliver the applicable merchandise to the user for selling and

a step to manage charging of the applicable merchandise price to the user and charging of the agent purchase service to the seller and

being used for provision of the agent merchandise purchase service to the users of the Internet connection service by an Internet provider.

According to the third aspect of the invention, an agent purchase system to provide the agent purchase service where the merchandise requested by the user is purchased for the user comprises

a terminal of the user and

a server to manage the agent purchase service and

the server comprising

request acceptance means which receives the specification of the purchased merchandise and the specification of the seller selling the merchandise via communication lines as the supplier of the merchandise so as to accept the request for agent purchase,

recording means to record, references and updates the credit level information about each of the sellers selling the merchandise via communication lines,

judgment means to judge whether to execute the requested agent purchase based on the credit level record of the seller, and

charge management means to manage charging of the agent purchase service rendered to the user.

In the preferred construction, the server further comprises

purchase means which executes the purchase procedures where the merchandise requested for agent purchase is purchased from the specified seller via communication lines according to the request contents received from the user.

In another preferred construction, the server comprises delivery means which records the delivery destination of the user who requested the agent purchase of the merchandise for each of the merchandises and instructs the merchandise transporter to deliver the merchandise purchased from the seller with specifying the destination.

In another preferred construction, the server further comprises:

purchase means which executes the purchase procedures where the merchandise requested for agent purchase is purchased from the specified seller via communication lines according to the request contents received from the user and

delivery means which records the delivery destination of the user who requested the agent purchase of the merchandise for each of the merchandises and instructs the merchandise transporter to deliver the merchandise purchased from the seller with specifying the destination.

In another preferred construction, the server comprises Internet server function to connect the terminal of the user to the Internet and

manages the agent purchase service for the merchandise sold by the seller on the web page of the seller to which the user connects via Internet.

In another preferred construction, the server comprises Internet server function to connect the terminal of the user to the Internet and

manages the agent purchase service for the merchandise sold by the seller on the web page of the seller to which the user connects via Internet and the request acceptance means

accepts the specification of the seller by specification of the Internet web page address.

In another preferred construction, the server

comprises Internet server function to connect the terminal of the user to the Internet and

manages the agent purchase service for the merchandise sold by the seller on the web page of the seller to which the user connects via Internet and

the request acceptance means

accepts the specification of the seller by specification of the Internet web page address and

the terminal of the user comprises

a web browser to display the web page of the seller and

ordering means to send the specification of the purchased merchandise and the specification of the seller as the supplier of the merchandise to the server so as to request agent purchase and

the ordering means comprising

means to specify the seller by sending, to the server, the address of the web page currently displayed on the web browser as the web page address of the seller.

In another preferred construction, the server comprises Internet server function to connect the terminal of the user to the Internet and

manages the agent purchase service for the merchandise sold by the seller on the web page of the seller to which the user connects via Internet and

the charge management means

charges and manages the fee of the agent purchase service of the user together with the Internet connection service fee.

According to another aspect of the invention, a server which manages the agent purchase service via communication lines comprises

request acceptance means which, by receiving from the user terminal the specification of the purchased merchandise and the specification of the seller selling the merchandise via communication lines as the supplier of the merchandise, accepts the request for agent purchase;

recording means to record, refer to or update the credit level information about each of the sellers selling the merchandise via communication lines,

judgment means to judge whether or not to execute the requested agent purchase based on the credit level record of the seller and

charge management means to manage charging for the agent purchase service provided to the user.

In the preferred construction, the server further comprises

purchase means which executes the purchase procedures where the merchandise requested for agent purchase is purchased from the specified seller via communication lines according to the request contents received from the user.

In another preferred construction, the server further comprises

delivery means which

records the delivery destination of the user who requested the agent purchase of the merchandise for each of the merchandises and

instructs the merchandise transporter to deliver the merchandise purchased from the seller with specifying the destination.

In another preferred construction, the server

comprises Internet server function to connect the terminal of the user to the Internet and

manages the agent purchase service for the merchandise sold by the seller on the web page of the seller to which the user connects via Internet.

In another preferred construction, the server

comprises Internet server function to connect the terminal of the user to the Internet and

manages the agent purchase service for the merchandise sold by the seller on the web page of the seller to which the user connects via Internet and

the request acceptance means

accepts the specification of the seller by specification of the Internet web page address.

In another preferred construction, the server

comprises Internet server function to connect the terminal of the user to the Internet and

manages the agent purchase service for the merchandise sold by the seller on the web page of the seller to which the user connects via Internet and

the charge management means

charges and manages the fee of the agent purchase service of the user together with the Internet connection service fee.

According to a further aspect of the invention, a computer readable memory containing the transaction management program for the agent purchase service via communication lines wherein

the transaction management program for the agent purchase service comprises

a request acceptance step which, by receiving from the user terminal the specification of the purchased merchandise and the specification of the seller selling the merchandise via communication lines as the supplier of the merchandise, accepts the request for agent purchase;

a recording step to refer to or update the credit level information about each of the sellers selling the merchandise via communication lines,

a judgment step to determine whether or not to execute the requested agent purchase based on the credit level record of the seller and

a charging management step to manage charging for the agent purchase service provided to the user.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing the configuration of an agent purchase system according to a first embodiment of the present invention;

FIG. 2 is a diagram showing an example of the agent purchase acceptance page according to the first embodiment of the present invention;

FIG. 3 is a diagram showing an example of display on the display screen of the user terminal used by the user according to the first embodiment of the present invention;

FIG. 4 is a block diagram showing the configuration of the server according to the first embodiment of the present invention;

FIG. 5 is a diagram showing an example of the seller information table managed by a transaction management database according to the first embodiment of the present invention;

FIG. 6 is a diagram showing the processing among the parties of the agent purchase according to the first embodiment of the present invention;

FIG. 7 is a flowchart to illustrate the operation of the agent purchase system according to the first embodiment of the present invention;

FIG. 8 is a diagram showing an example of the web page introducing the sellers according to a second embodiment of the present invention;

FIG.9 is a block diagram showing the configuration of the server according to the second embodiment of the present invention;

FIG. 10 is a flowchart to illustrate the processing by the agent purchase system according to the second embodiment of the present invention;

FIG. 11 is a diagram showing an example of the web page where the sellers are registered according to a third embodiment of the present invention;

FIG. 12 is a block diagram showing the configuration of the server according to the second (third?) embodiment of the present invention;

FIG. 13 is a diagram showing an example of the login page for the settlement confirmation page according to a fourth embodiment of the present invention; and

FIG. 14 is a flowchart to illustrate the processing by the agent purchase system according to the fourth embodiment of the present invention.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

The present invention provides a method of business to render the agent purchase service where the agent buys the merchandise for the user in the electronic commerce via Internet or the like as well as the agent purchase system to run the agent purchase service.

In addition, the present invention is provided with a system to determine the credit level of the merchandise seller on the network and to properly judge whether to execute the requested agent purchase based on such credit level. Thus, the present invention avoids various troubles which often occur in the electronic commerce and provides the agent purchase service user with safe utilization of the electronic commerce.

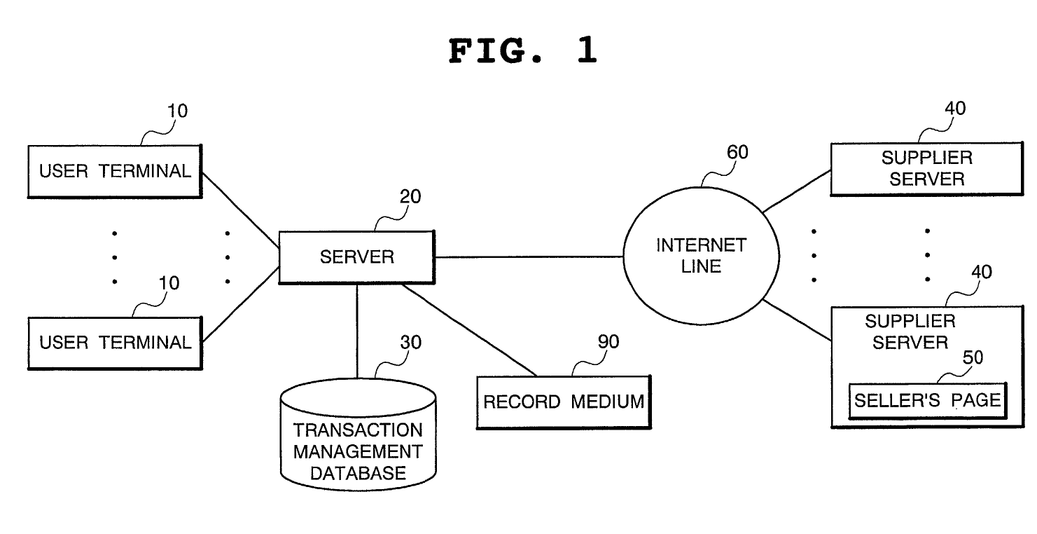

FIG. 1 is a block diagram showing an example of the configuration for an agent purchase system 100 according to a first embodiment of the present invention.

In the example of FIG. 1, the agent purchase system 100 according to this embodiment is run by an Internet provider, which is a company providing the Internet connection service for connection between a user terminal 10 and an Internet line 60.

Referring to FIG. 1, the agent purchase system 100 of this embodiment comprises the user terminal 10, a server 20 to control and manage the processing of the agent purchase system 100, and a transaction management database 30 to record the credit level information about the merchandise seller on the Internet.

The server 20 has a function of the Internet server to connect the user terminal 10 with the Internet line 60 and accepts requests for agent purchase from the user terminal 10.

Further, many supplier servers 40 are connected to the Internet and provide web pages 50 of the sellers selling the merchandise on the Internet. The user terminal 10 connects one of the supplier servers 40 through the server 20 and accesses the web page 50 of a seller.

The user terminal 10 is a terminal capable of using the Internet via the server 20. It can be a PC, a notebook PC or other information processing terminal or a portable phone, PHS or any other communication terminal with Internet utilization function such as the i-mode system.

The user, who places an order for the merchandise, uses the user terminal 10 to be connected to the Internet line 60 and displays the web page 50 of the seller selling the merchandise on a web browser 11.

Then, if the user wants to enjoy the agent purchase service for the merchandise sold on the displayed web page 50, the user orders the agent purchase by sending the data to specify the merchandise to be purchased (name of the merchandise, purchase quantity and other data required for purchasing) and the URL (Uniform Resource Locator) or the Internet address of the web page 50 to the server 20.

The ordering process for agent purchase can be implemented by a method where the data required for the agent purchase are sent to the server 20 via e-mail or a method where the manager of the agent purchase system 100 (shopping agent) opens a web site to accept the agent purchase so that the user fills in the boxes for merchandise name and URL displayed on this web page (Further, in this method using the web site for order acceptance, the server 20 can be provided with the web server function so that the web site can be opened via the server 20).

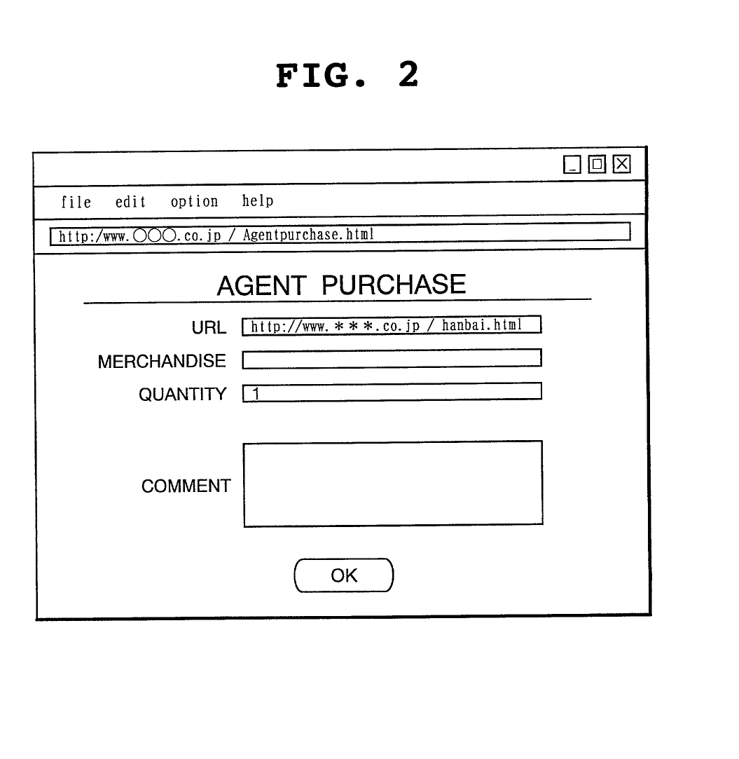

FIG. 2 shows an example of the page for agent purchase acceptance according to this embodiment.

Referring to the example of FIG. 2, the agent purchase acceptance page has boxes to input the URL of the seller's page 50, the merchandise to be purchased and the purchased quantity respectively and a button to instruct transmission of the input data to the server 20 and further has an input box to give comments about the agent purchase. The user can order the agent purchase by accessing the web site of the shopping agent, displaying this web page, inputting the required data to the boxes and then clicking the button for transmission instruction.

In addition, the user terminal 10 may be provided with an order section 12 to send the data for agent purchase ordering to the server 20.

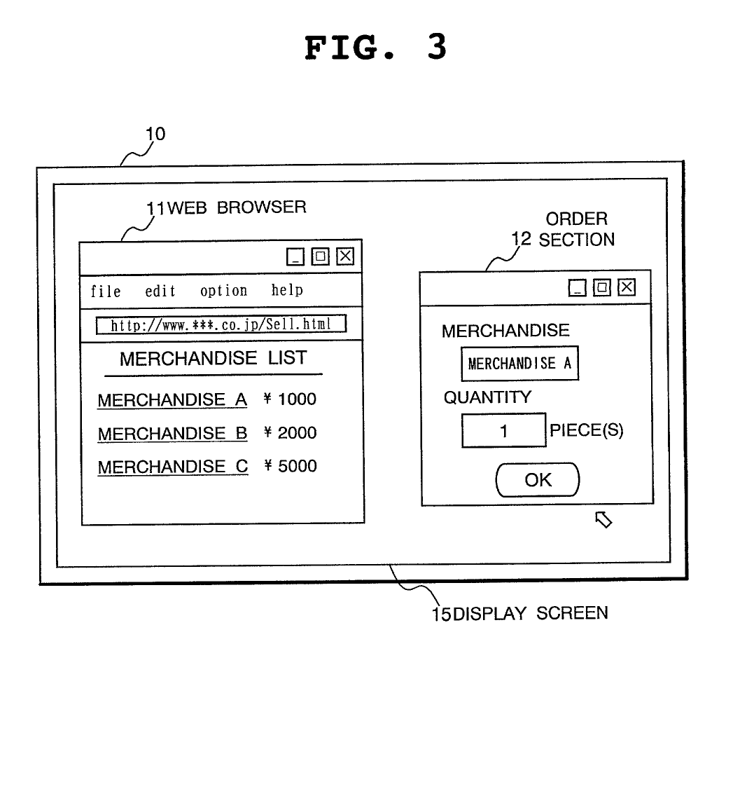

FIG. 3 shows an example of display on a display screen 15 on the user terminal 10 according to this embodiment. In the example of FIG. 3, the user terminal 10 is provided with a web browser 11 and an order section 12 and their user interfaces are displayed on the display screen 15.

Corresponding to the user's ordering operation, the order section 12 displays an input window for specification of the purchased merchandise on the display screen of the user terminal 10 (and other areas for data input on the display screen), accepts the input, acquires the URL data of the seller's web page 50 currently displayed on the web browser 11 and sends these data to the server 20.

In the example of FIG. 3, the window of the order section 12 has an input section for input of the name of the purchased merchandise and the purchased quantity as well as a button to instruct purchasing to the server 20.

The user displays the seller's page 50 on the web browser 11, inputs the purchased merchandise name and the purchased quantity to the order section 12 and clicks the purchase instruction button with placing the cursor there so that the order section 12 sends the information required for agent purchase request (URL of the seller's page 50, purchased merchandise and quantity) to the server 20 and the request for agent purchase is executed.

Thus, the user can more easily order the agent purchase.

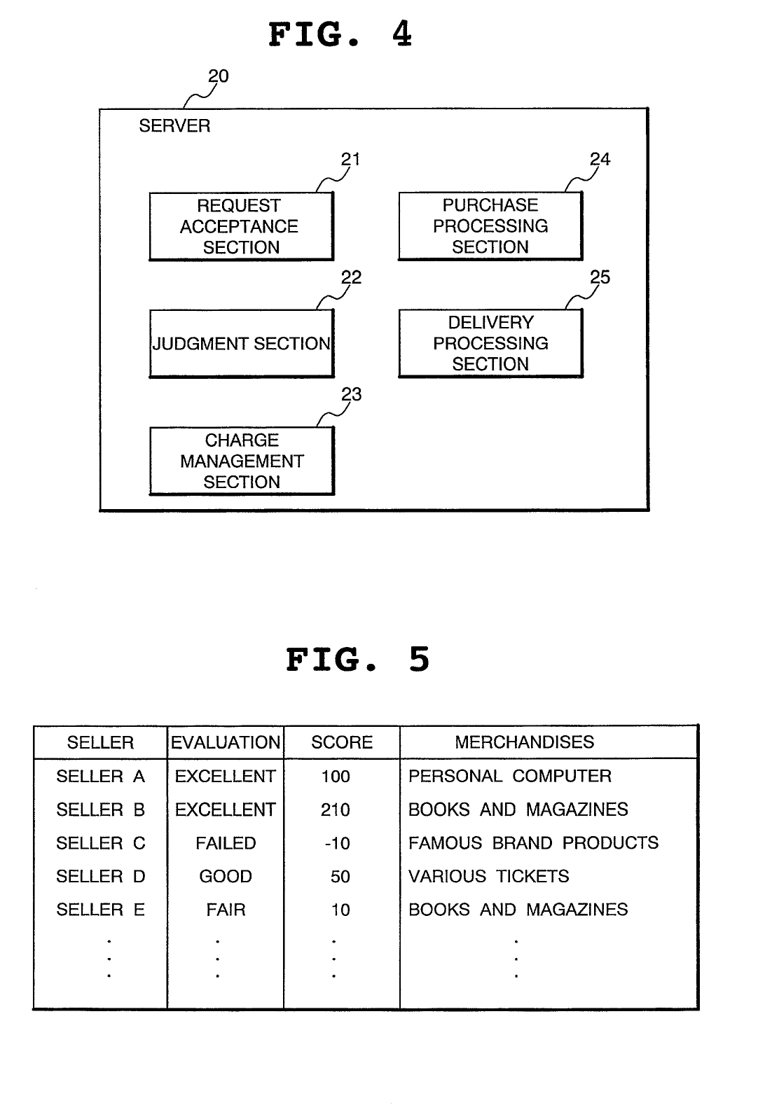

FIG. 4 is a block diagram showing the configuration of the server 20 according to this embodiment.

Referring to FIG. 4, the server 20 comprises a request acceptance section 21 to accept the agent purchase request from the user, a judgment section 22 to judge whether to execute the requested agent purchase and a charge management section 23 to manage charging of the agent purchase service fees, prices of the merchandises purchased by the agent, and other fees. In addition, the server 20 is provided with devices to assist and implement other procedures and processing of the agent purchase: a purchase processing section 24 to execute the purchase procedures for the merchandise and a delivery processing section 25 to deliver the merchandise of agent purchase to the user.

The request acceptance section 21 accepts requests for agent purchase sent from the user terminal 10.

If the request is sent from the above order section 12 or the web page to accept orders is used here, the data sent for agent purchase request can be received according to a predetermined form. In such case, the request acceptance section 21 can automatically extract the purchased merchandise, the seller's URL and other necessary data from the received agent purchase request data.

The judgment section 22 judges the credit level of the seller specified as the supplier of the merchandise in the agent purchase and decides whether or not to execute the agent purchase.

For the credit level judgment, the judgment section 22 records the sellers'transaction results data so far (for example, the number, quantity and amount of transactions so far, whether the seller has made any illegal transaction or any breach of rules, the reputation among buyers and so on) in the transaction management database 30 and, referring to such data, judges whether any problem is anticipated in the transaction.

In the credit level judgment, the judgment section 22 can make automatic judgment by, for example, giving scores to the sellers' data recorded in the transaction management database 30 according to their types. For example, a certain score may be added for each transaction or the users may be requested to score the seller based on the transaction result of the agent purchase (with opening a web site for scoring and requesting the purchasers to input a score from 1 to 5, for example) so that such scores are summed. In this case, to recommend the seller who marks a good score, a web page with links to excellent sellers' pages 50 is preferably opened so that the ordering persons are informed that they are excellent sellers.

On the other hand, if the purchased merchandise is of a poor quality or any other vicious transaction is made, the score will be reduced or the applicable seller will be excluded from the sellers for transaction. This can be made according to notification from users (from the above web page for scoring, for example) or the transaction result between the shopping agent itself and the applicable seller (no delivery of merchandise though order has been placed, for example).

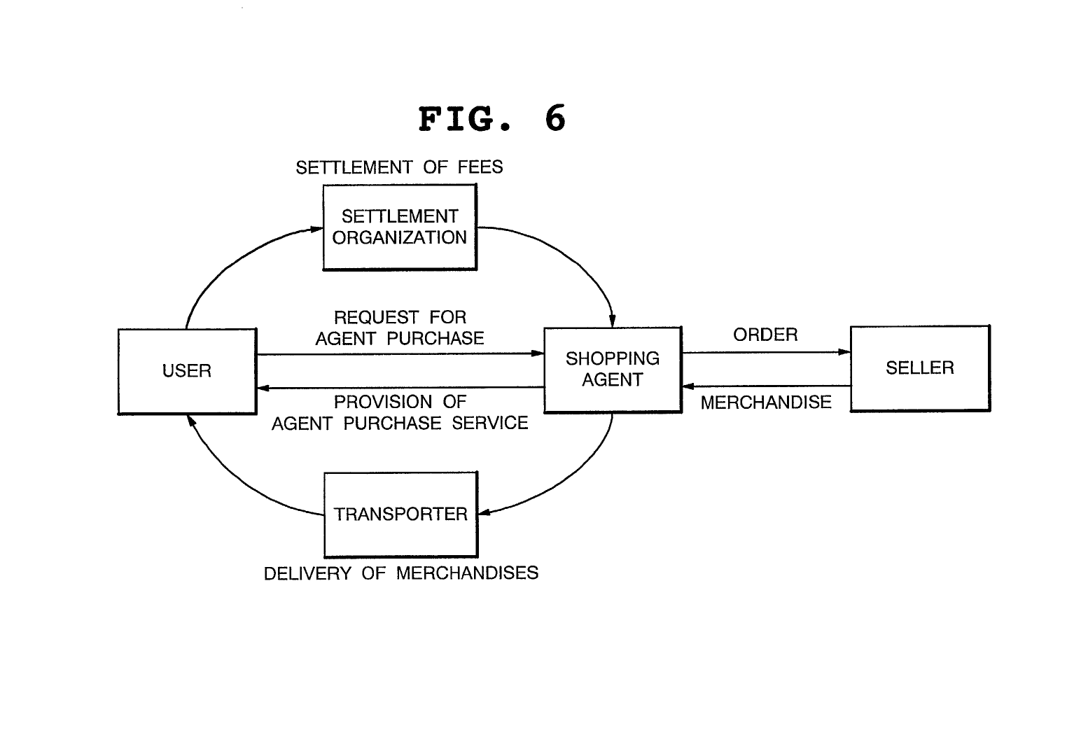

FIG. 5 shows an example of the seller information table managed by the transaction management database 30 according to this embodiment.

Referring to the example of FIG. 5, the seller information table of the transaction management database 30 records the above scores of the sellers, category of the sold merchandises and transaction evaluations (Excellent, Good, Fair and Failed. In case of “Failed”, the agent purchase is not accepted). In addition, the number of transactions between the sellers and the shopping agent and the transaction contents so far and the evaluation of the buyers related to the transactions so far may be recorded onto a separate table or such information may be displayed on the web page so that the users can be informed of such data.

The judgment section 22 may automatically judge, when the seller's score is not less than the specified value and the seller is free from any illegal or breach record in the transactions so far, that the agent purchase of the merchandise from that seller should be executed.

The charge management section 23 calculates the fee of the agent purchase service, payment for the merchandise of the agent purchase and other fees to be charged to the users.

Note here that the agent purchase system 100 according to the present embodiment provides the Internet connection service in addition to the agent purchase service to the user as the ordering person. Therefore, it is preferable to treat these fees together in payment charging (or collection). For example, the service fee or the like charged for the agent purchase is charged together with the Internet connection fee so that it is paid by the same method as that for the Internet connection fee, which is collective transfer from the user's bank account once a month. Thus, the user can settle the service fee payment together with the Internet connection fee, which is an easy and labor-saving method of settlement.

The purchase processing section 24 purchases the merchandise requested for purchase by the agent.

For example, to enable the manager of the agent purchase system 100 to quickly follow the merchandise purchase procedures, the purchase processing section 24 displays the web page at the supplier's URL as well as the merchandise and quantity to be purchased and other information on the PC or other terminal connected with the Internet. In case the URL is of the registered seller for which the purchase method is already known, an e-mail for merchandise purchase may be automatically sent to the seller.

The delivery processing section 25 delivers the merchandise of the agent purchase to the user. It prints out the tags indicating the address of the user and the merchandise to be delivered and requests an outside transporter to deliver the merchandize together with such tag, for example.

FIG. 6 shows the processing among the parties related to the agent purchase according to this embodiment.

Referring to FIG. 6, upon request for agent purchase from the user, the shopping agent who runs the agent purchase system according to this embodiment renders the agent purchase service to the user by ordering the requested merchandise to the seller, obtaining such merchandise and delivering the merchandise to the user via a transporter. The service fee and the price of the merchandise are settled via the settlement organization such as credit card companies and banks.

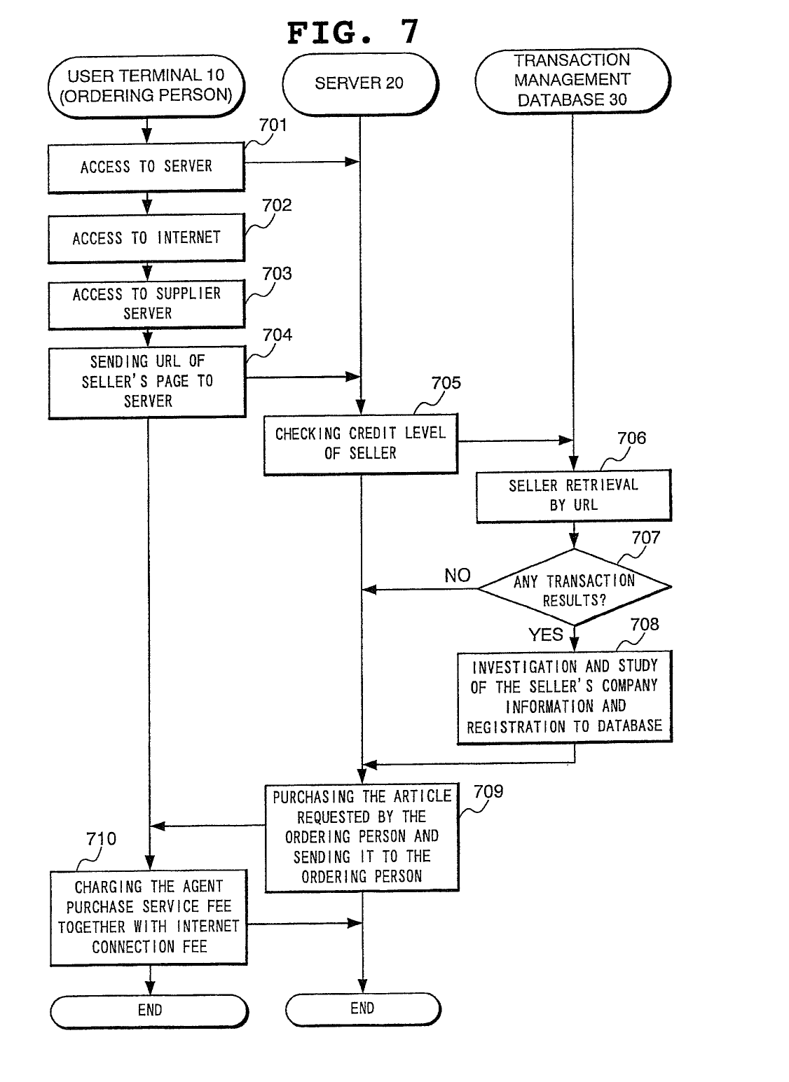

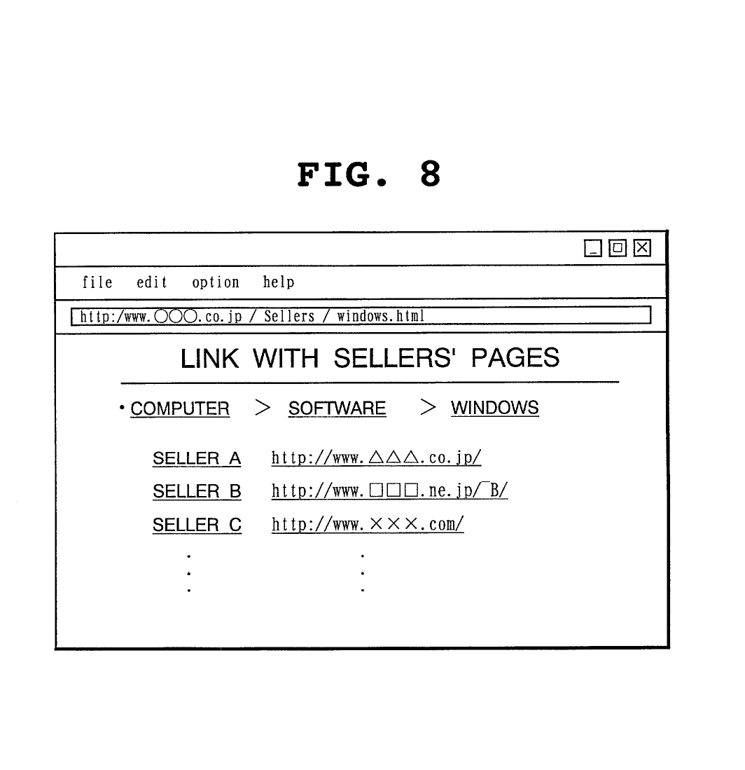

FIG. 7 is a flowchart to illustrate the operation of the agent purchase system according to the first embodiment of the present invention.

Referring to FIG. 7, the ordering person or the user of the agent purchase service accesses from his/her user terminal 10 to the server 20 (Step 701) and accesses the Internet line 60 (Step 702).

The ordering person can thus access various web servers on the Internet and display the web pages opened at the accessed web server on the web browser 11 of the user terminal 10.

Next, the ordering person accesses the supplier server 40, which is the web server opening the web page 50 of the seller selling the merchandise and displays the web page 50 of the seller on the web browser 11 (Step 703).

Next, the ordering person refers to various product information on the home page of the web page 50 of the seller and decides the merchandise to be purchased and then sends the instruction to order the merchandise not to the supplier server 40, but to the server 20 controlling the agent purchase (Step 704).

The notified information contains the URL of the seller's web page 50 and the purchased contents (name, quantity etc. of the purchased merchandise) and such information is recorded to the transaction management database 30 as the agent purchase request information.

Upon receipt of the purchase request, the server 20 extracts the seller's URL and the name and quantity of the purchased merchandise from the received data and records such information. In addition, the server 20 refers to the transaction management database 30 to check the credit level of the seller (Step 705).

The credit level checking is firstly processed based on the sent URL. The transaction management database 30 is searched for any record about the seller selling the merchandise at the applicable URL (Step 706). If that URL is registered in the transaction management database 30, the record of the seller's credit level and the result data of the transactions made so far is used for determination of the credit level. Based on such credit level, whether or not to execute the agent purchase is judged (Step 707).

If that URL is not recorded in the transaction management database 30, the requested agent purchase may be canceled here. Alternatively, if the manager of the agent purchase system 100 investigates and studies the company information about the seller with that URL and judges that there is no problem about the transaction, the agent purchase is decided to be executed and the URL is registered to the transaction management database 30 (Step 708).

In case it is decided not to execute the agent purchase according to the credit level judgment, a notice not to accept the agent purchase (with describing the reason when necessary) is sent to the user terminal 10. This completes the processing of the agent purchase system 100 upon agent purchase request.

In case the agent purchase is decided to be executed, the manager of the agent purchase system 100 purchases the merchandise specified by the ordering person for the ordering person and delivers it to the ordering person (Step 709).

Upon receipt of the merchandise, the ordering person settles the price payment by the same method as the payment method for the Internet connection fee to the Internet provider 20 (Step 710).

In the above explanation about this embodiment, the seller is supposed to be any seller selling the merchandise on the network and any agreement with the shopping agent is not required in advance. However, the seller can also have a merchandise selling system linked with this agent purchase system service.

For example, the seller's page 50 can have links with the web pages (home page or agent purchase request page) of the shopping agent to which the agent purchase can be requested or the results of transactions so far including the number of merchandise sales through agent purchase service and the transaction credit level judged by the server 20 can be displayed.

Besides, a form to request the agent purchase opened on the shopping agent's web site can be shown on the seller's page 50. In this case, the program should be arranged so that the data input to the form are sent to the shopping agent. The seller may display the agent purchase request form in a style suitable for purchasing the merchandise of that seller by displaying the name of the merchandise etc. in advance in the input boxes for the purchased merchandise and the supplier, for example.

According to this embodiment, the fee of the agent purchase service can be collected once a month together with the Internet connection service fee. The price of the merchandise itself may be similarly collected together with the Internet connection service fee, may be settled by the credit card (which is used for payment of the Internet connection service fee), may be settled cash-on-delivery basis when the merchandise is delivered or may be paid in advance to the shopping agent.

Next, a second embodiment of the present invention is described below.

Though the buyer himself/herself finds out the seller's page 50 selling the merchandise the buyer desires to purchase in the first embodiment, the shopping agent helps the buyer and introduces excellent sellers' pages 50 to the user in this embodiment.

For example, a specific example of this embodiment is as follows.

Suppose the manager of the agent purchase system opens the web page to accept the agent purchase and provides the web page indicating the list of the sellers the agent purchase system can accept the agent purchase and the links to the applicable sellers' pages 50. Especially excellent sellers may be marked by an icon showing its excellence at the indication box of the seller. This web page to introduce the sellers can be automatically generated by the server 20 according to the credit level data provided by the judgment section 20 for the sellers registered to the agent purchase system.

On the web page introducing the sellers, the sellers can be displayed by category of the merchandise on sale so that the user can easily find out the appropriate seller.

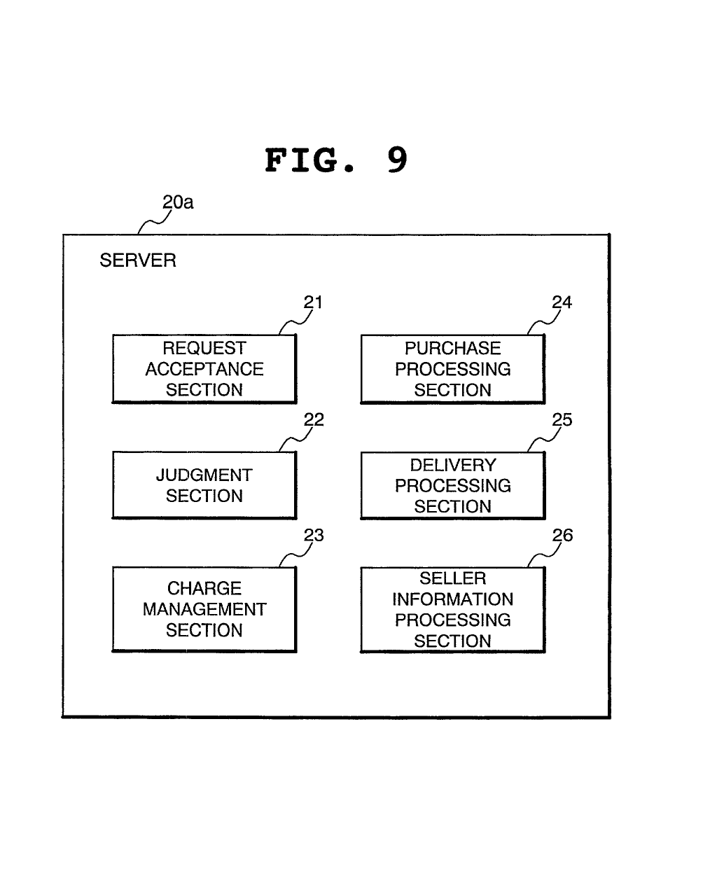

FIG. 8 shows an example of the web page introducing the sellers according to this embodiment.

In the example of FIG. 8, the pages are separated by the merchandise to be sold and the sellers' pages 50 for that merchandise are displayed: the list of the sellers selling merchandise related to the computer software Windows is displayed. The indication of each seller's name on this page is linked with the applicable seller's page 50 or the page showing any article introducing the applicable seller. Just by clicking the mouse cursor on the indication, the user can display such page. In the example of FIG. 8, the name and URL of the sellers are indicated on the web page, but the number of transactions with the seller, evaluation and other data may be similarly displayed in the form of a table in addition to them.

FIG. 9 is a block diagram showing the configuration of the server 20a according to this embodiment.

Referring to FIG. 9, the server 20a of this embodiment is provided with the seller information processing section 26 to control provision of the sellers' information to the user in addition to the configuration of the server 20 in the first embodiment. The seller information processing section 26 generates the web page to introduce the sellers as described above from the seller information recorded in the transaction management database 30 and searches for the seller selling the merchandise the user wants to purchase and so on.

In case the merchandise requested for agent purchase is not the one sold by specific sellers only (daily commodities, foods etc.), it is not always necessary for the user to specify the seller when requesting the agent purchase and the agent purchase may be requested just by specifying the merchandise and quantity to be purchased.

In such case, the shopping agent may introduce the web page 50 of the sellers selling the applicable merchandise retrieved by the seller information processing section 26 to the user or may select the seller (The server 20 automatically selects the excellent seller with referring to the transaction results in the past of the sellers, for example) for agent purchase of the applicable merchandise.

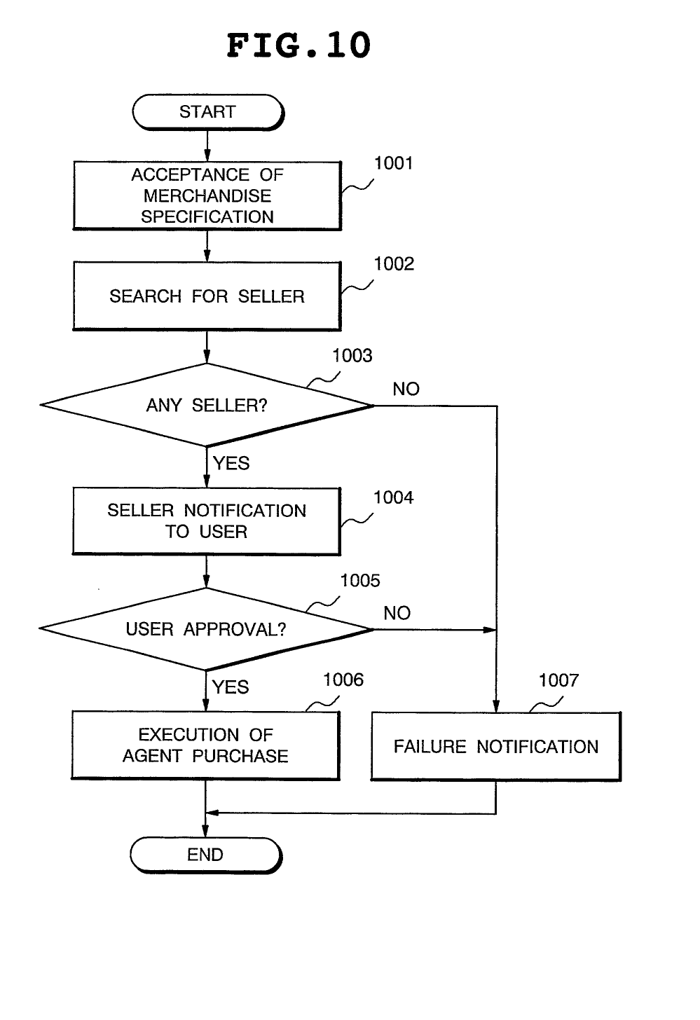

FIG. 10 is a flowchart to illustrate the acceptance processing of the agent purchase according to this embodiment. In FIG. 10, based on the specification of the purchased merchandise, the seller information processing section 26 retrieves the seller of the merchandise.

Firstly, specification of the purchased merchandise is received from the user terminal 10 as the merchandise name/quantity data (Step 1001). The seller selling the merchandise requested for purchase is searched from the seller data in the transaction management database 30 based on the merchandise name or the like (Step 1002). Then, if any seller enabling acceptance of agent purchase is registered (Step 1003), that seller is notified to the user (Step 1004) so that the approval for purchase from that seller is obtained. If the user approves purchase from that seller (Step 1005), the agent purchase of the merchandise specified by the user from that seller is executed (Step 1006).

If several sellers are hit at Step 1004, the list of the applicable sellers may be presented to the user so as to accept selection of the seller from the list. Alternatively, the server 20 may select the seller for agent purchase from the sellers hit in retrieval and make decision without obtaining approval from the user (i.e. without Steps 1004 or 1005).

Further, in case the judgment section 22 judges that the agent purchase cannot be executed from the seller specified by the user as the merchandise supplier, other sellers selling the applicable merchandise from which the agent purchase is available can be introduced to the user by referring to the seller pages 50 classified by the merchandise.

If the merchandise the user wants to purchase is an article for which any seller authorized as the supplier for agent purchase has not been registered yet, the agent purchase should not be necessarily refused at once. The seller selling the applicable merchandise may be found out by search and investigation over networks or the merchandise sold at actual shop (not on the network) may be bought as the agent purchase service.

According to this embodiment, information about the sellers as the agent purchase suppliers is provided to the user and, upon consultation for the merchandise requested to be purchased, the sellers for the applicable merchandise is searched for and investigated. If the agent purchase cannot be made from the seller the user desires to buy the merchandise, the seller enabling the agent purchase who sells the applicable merchandise can be introduced. Thus, the more friendly and easily utilized agent purchase service can be provided.

Next, a third embodiment of the present invention is described below.

The third embodiment of the present invention is characterized by the special service provision which cannot be achieved by the agent purchase from the outside seller on the network (the seller bears the fee of the agent purchase service, for example) by registering the sellers (or some of them) as the merchandise suppliers to this agent purchase system.

Specific examples of this embodiment include the one as described below.

In the web site of the shopping agent, the seller pages 50 of the registered sellers are displayed and the sold merchandise is delivered by the shopping agent to the ordering person. In addition, intermediary of other merchandise transactions is processed in the same way as the method described in the above embodiments. Thus, the shopping agent serves as an agent not only for purchasing procedures but also for sales procedures.

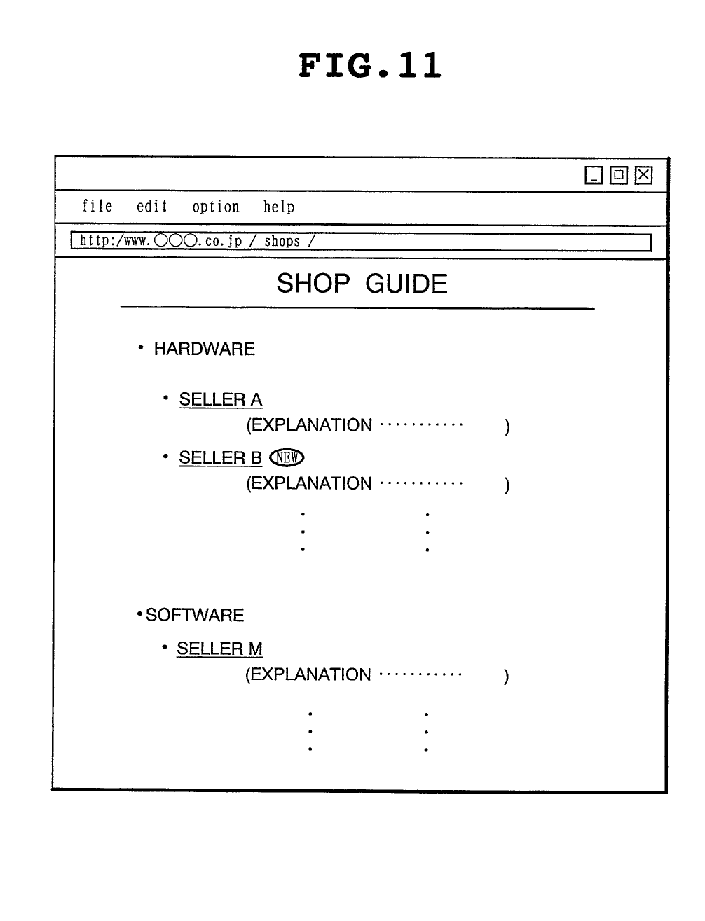

FIG. 11 shows an example of the web page registering sellers according to this embodiment. Referring to the example of FIG. 11, in the web site of the shopping agent, the list of the registered sellers are presented by the category of the sold merchandise such as “hardware” and “software”. The place for indication of each seller's name is linked with the applicable seller's page 50 and the description of the applicable seller is provided. The seller's page 50 is not necessarily opened in the web site of the shopping agent and can be opened on the outside supplier server 40.

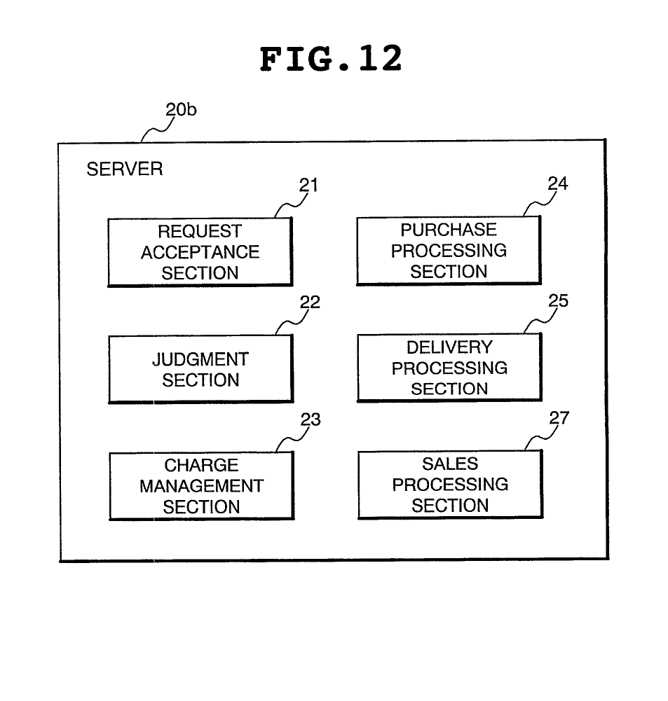

FIG. 12 is a block diagram showing the configuration of a server 20b according to this embodiment.

Referring to FIG. 12, the server 20a of this embodiment is provided with a sales processing section 27 to manage the sales of the merchandise from the registered seller's page 50 in addition to the configuration of the server 20 in the first embodiment. The sales processing section 27 processes the sales of the merchandise by the registered sellers and controls the sales of the merchandise in the e-commerce including new registration of sellers.

Thus, the seller is exempted from troublesome clerical works related to the merchandise sales in e-commerce for price settlement and merchandise delivery. In addition, use of the existing settlement system run by the shopping agent largely saves the cost required for new establishing of a shop. Further, the merchandise price receiving from the shopping agent eliminates the need of handling the ordering person's credit card. This makes the card information management cost unnecessary.

In this embodiment, the fee for the agent purchase (selling) service for the merchandise sold by the registered sellers can be borne by the seller.

Next, a fourth embodiment is described below.

Ordering in the above embodiments has been described, for easier explanation of the agent purchase, with the example comprising one operation where the order instruction is sent from the ordering section 12 of the user terminal 10, for example. It is preferable, however, that the server 20 confirms the user to see whether the user has requested the agent purchase and, after receiving the reply, executes the agent purchase.

In this embodiment, order by other person pretending to be the applicable user or whether the user has made any mistake in ordering operation can be checked through confirmation with the requesting user.

Further, by sending the information of the judgment result on whether or not to accept the agent purchase request by the judgment section 22 at the same time, the user can check the result.

The confirmation whether the agent purchase has been requested or not can be made by the server 20, which sends a confirmation e-mail to the user's e-mail address (or to the user terminal 10). For this e-mail address, the address provided to the user by the shopping agent who serves as the Internet provider and other address specified by the user may be used.

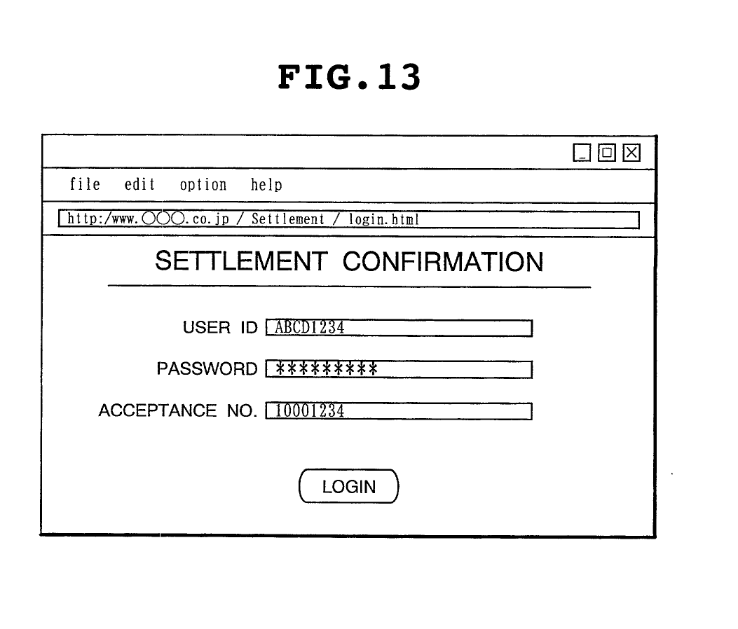

For example, in this confirmation e-mail, the URL of the settlement confirmation page, which is a web page to confirm the settlement is described so that the user can display the web page at that URL (using the web browser 11 or the like on the user terminal 10), log in with inputting the user ID (of the Internet connection service), password and the acceptance No. described on the confirmation e-mail and, if the requested contents displayed on the settlement confirmation page are correct, and click the purchase confirmation button in the page with placing the mouse cursor there to complete the ordering procedure. FIG. 13 shows an example of the log-in page to the settlement confirmation page according to this embodiment.

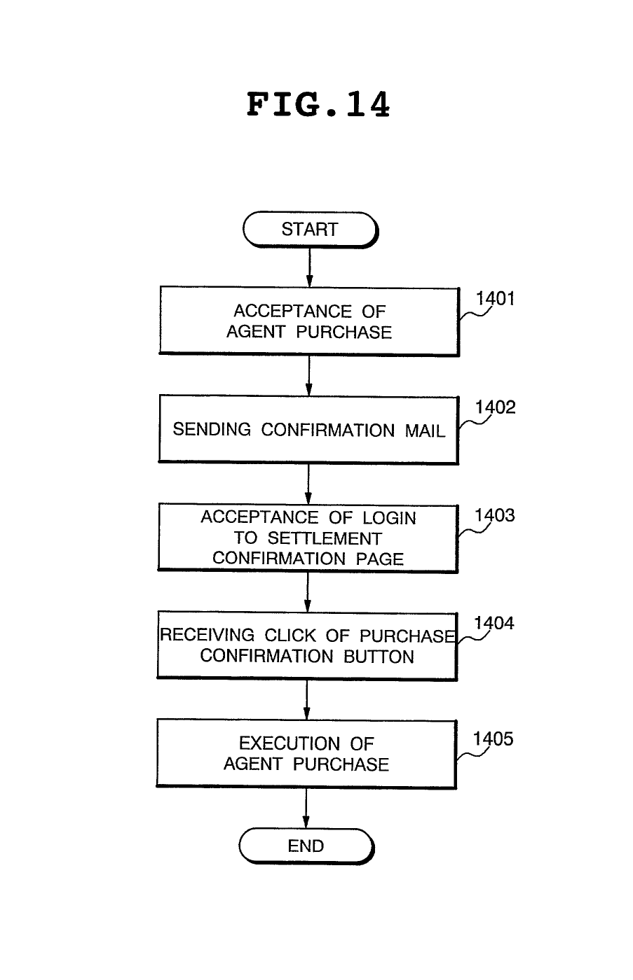

FIG. 14 is a flowchart to illustrate the processing other agent purchase system according to this embodiment.

Referring to FIG. 14, in this embodiment, upon receipt of the agent purchase request from the user (Step 1401), the confirmation e-mail is sent to that user (Step 1402). Then, the user logs in the settlement confirmation page using the acceptance No. described in the confirmation mail (Step 1403) and, by clicking the purchase confirmation button (Step 1404), completes the acceptance processing of that ordering and the server executes the requested agent purchase (Step 1405).

In the embodiments above, the personal information of the buyer is not notified to the seller at all and the seller makes the transaction with the shopping agent only. If the purchased merchandise requires procedure to register the buyer as in the case of a car or a handy phone, the shopping agent can follow the procedure for the buyer and subscribe the handy phone service using the name of the buyer before purchasing the merchandise. In this style, the personal information of the buyer is known to the seller, but the buyer can enjoy the service to follow the troublesome purchase procedure of these merchandise for the buyer.

Thus, the agent purchase system of the present invention can keep the personal information of the buyer from being known to outside and avoid danger in e-commerce and further provide services to follow the procedures for the buyer when the transaction requires troublesome procedures or when the buyer cannot understand the procedures of foreign seller's page (because the explanation is given in a foreign language).

The agent purchase method of the above embodiments can be of course realized by hardware for the request acceptance section 21, the judgment section 22, the charge management section 23 and other functions of the server, and also realized by loading a computer program provided with these functions into the memory of a computer processor. Such computer program is stored to the magnetic disk, semiconductor memory or other recording medium 90. The program is loaded from the recording medium 90 to the computer processor so as to control the operation of the computer processor and achieve the above functions.

As described above, the agent purchase method according to the present invention realizes the effects as described below.

Firstly, the merchandise purchasing through online shopping, which has conventionally involved much danger and concern is made by an agent and the user can feel safe about transactions.

Secondly, because the transaction results data of the sellers are recorded in the database, the credit level for transactions can be effectively and correctly judged with referring to such records.

Thirdly, the service fee can be settled together with the Internet connection fee, and an easy and labor-saving settlement method can be utilized.

The fourth effect results from receiving of agent purchase request via Internet or other communication line. The judgment of the credit level of the applicable seller and judgment whether or not to execute the agent purchase and other works in the agent purchase service can be automated, which realizes efficient agent purchase service.

The fifth effect is that the user can freely choose the web page of the merchandise seller in the Internet on the user terminal and select the merchandise to be purchased and the supplier and request the agent purchase by easy operation.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. An agent purchase method for agent purchase via communication lines comprising the steps of:
a step which, by receiving from the user terminal the specification of the purchased merchandise and the specification of the seller selling said merchandise via communication lines as the supplier of said merchandise, accepts the request for agent purchase of said merchandise;
a step to refer to or update the credit level record of said seller for transactions;
a step to purchase the merchandise requested for agent purchase from said seller and to deliver the merchandise to said user and
a step to manage charging for the agent purchase service provided to said user.

2. An agent purchase method according to claim 1 wherein:
the credit level information about each of said sellers selling the merchandise via communication lines is recorded in the database and
said database is searched for the credit level record of the seller specified as the supplier of said merchandise so that the requested agent purchase is executed only when a sufficiently good credit level is recorded.

3. An agent purchase method according to claim 1 which is
used for provision of the agent purchase service to the users of the Internet connection service rendered by an Internet provider.

4. An agent purchase method according to claim 1 wherein:
said agent purchase is requested
with specification of said seller by specifying the address of the Internet web page of the seller.

5. An agent purchase method according to claim 1 which is
used for provision of the agent purchase service to the users of the Internet connection service by an Internet provider wherein:
said Internet provider charges the users of said Internet connection service to pay the utilization fee of the agent purchase service together with the fee of the Internet connection service and collects these fees together.

6. An agent purchase method according to claim 1 which is
used for provision of the agent purchase service to the users of the Internet connection service by an Internet provider wherein:
said agent purchase service is requested
with specification of said seller by specifying the address of the Internet web page of the seller and
said Internet provider charges the users of said Internet connection service to pay the utilization fee of the agent purchase service together with the fee of the Internet connection service and collects these fees together.

7. An agent purchase method according to claim 1 further comprising:
a step to classify said sellers from which the agent purchase is available by the category of the merchandise to be sold and to record such list and
a step to search said list for the seller selling the merchandise requested for agent purchase from the user.

8. An agent purchase method according to claim 1 further comprising:
a step to record the credit level information for each of said sellers selling the merchandise via communication lines to a database,
to search said database for the credit level record of said seller specified as the supplier of said merchandise and to execute the requested agent purchase only when a sufficiently good credit level is recorded,
a step to classify said sellers from which the agent purchase is available by the category of the merchandise to be sold and to record such list and
a step to search said list for the seller selling the merchandise requested for agent purchase from the user.

9. An agent purchase method according to claim 1 further comprising:
a step to search said communication lines for the seller selling the merchandise requested for agent purchase from the user,
a step to investigate the transaction credit level of the seller selling the applicable merchandise hit by said search and
a step to execute the agent purchase from the applicable seller when the seller hit by said search has a sufficient credit level.

10. An agent purchase method according to claim 1 further comprising:
a step to register the sellers selling the merchandise and
a step to make the information about the merchandises sold by the registered sellers public on communication lines.

11. An agent purchase method according to claim 1 wherein
the fee of the agent purchase service for the merchandise sold by said registered seller is charged to the applicable seller.

12. An agent purchase method for agent purchasing via communication lines comprising the steps of:
a step to register the sellers selling the merchandise,
a step to open the information about the merchandise sold by the registered sellers on communication lines,
a step to receive request for selling of the merchandise the user desires to purchase from the user terminal,
a step to deliver the applicable merchandise to said user for selling and
a step to manage charging of the applicable merchandise price to said user and charging of the agent purchase service to said seller and
being used for provision of the agent merchandise purchase service to the users of the Internet connection service by an Internet provider.

13. An agent purchase system to provide the agent purchase service where the merchandise requested by the user is purchased for the user comprising:
a terminal of the user and
a server to manage the agent purchase service and
said server comprising
request acceptance means which receives the specification of the purchased merchandise and the specification of the seller selling said merchandise via communication lines as the supplier of said merchandise so as to accept the request for agent purchase,
recording means to record, references and updates the credit level information about each of said sellers selling the merchandise via communication lines,
judgment means to judge whether to execute the requested agent purchase based on the credit level record of said seller, and
charge management means to manage charging of the agent purchase service rendered to the user.

14. An agent purchase system according to claim 13 wherein
said server further comprises
purchase means which executes the purchase procedures where said merchandise requested for agent purchase is purchased from said specified seller via communication lines according to the request contents received from said user.

15. An agent purchase system according to claim 13 wherein:
said server comprises delivery means which records the delivery destination of the user who requested the agent purchase of the merchandise for each of said merchandises and instructs the merchandise transporter to deliver the merchandise purchased from said seller with specifying the destination.

16. An agent purchase system according to claim 13 wherein:
said server further comprises:
purchase means which executes the purchase procedures where said merchandise requested for agent purchase is purchased from said specified seller via communication lines according to the request contents received from said user and
delivery means which records the delivery destination of the user who requested the agent purchase of the merchandise for each of said merchandises and instructs the merchandise transporter to deliver the merchandise purchased from said seller with specifying the destination.

17. An agent purchase system according to claim 13 wherein:
said server comprises Internet server function to connect said terminal of the user to the Internet and
manages the agent purchase service for the merchandise sold by said seller on the web page of said seller to which the user connects via Internet.

18. An agent purchase system according to claim 13 wherein:
said server comprises Internet server function to connect said terminal of the user to the Internet and
manages the agent purchase service for the merchandise sold by said seller on the web page of said seller to which the user connects via Internet and said request acceptance means
accepts the specification of said seller by specification of the Internet web page address.

19. An agent purchase system according to claim 13 wherein:
said server
comprises Internet server function to connect said terminal of the user to the Internet and
manages the agent purchase service for the merchandise sold by said seller on the web page of said seller to which the user connects via Internet and
said request acceptance means
accepts the specification of said seller by specification of the Internet web page address and
said terminal of the user comprises
a web browser to display the web page of said seller and
ordering means to send the specification of the purchased merchandise and the specification of said seller as the supplier of said merchandise to said server so as to request agent purchase and
said ordering means comprising
means to specify said seller by sending, to said server, the address of the web page currently displayed on said web browser as the web page address of said seller.

20. An agent purchase system according to claim 13 wherein:
said server
comprises Internet server function to connect said terminal of the user to the Internet and
manages the agent purchase service for the merchandise sold by said seller on the web page of said seller to which the user connects via Internet and
said charge management means
charges and manages the fee of the agent purchase service of said user together with the Internet connection service fee.

21. A server which manages the agent purchase service via communication lines comprising:
request acceptance means which, by receiving from the user terminal the specification of the purchased merchandise and the specification of the seller selling said merchandise via communication lines as the supplier of said merchandise, accepts the request for agent purchase;
recording means to record, refer to or update the credit level information about each of the sellers selling the merchandise via communication lines,
judgment means to judge whether or not to execute the requested agent purchase based on the credit level record of said seller and
charge management means to manage charging for the agent purchase service provided to said user.

22. A server according to claim 21 further comprising:
purchase means which executes the purchase procedures where said merchandise requested for agent purchase is purchased from said specified seller via communication lines according to the request contents received from said user.

23. A server according to claim 21 comprising:
delivery means which
records the delivery destination of the user who requested the agent purchase of the merchandise for each of said merchandises and
instructs the merchandise transporter to deliver the merchandise purchased from said seller with specifying the destination.

24. A server according to claim 21 which:
comprises Internet server function to connect said terminal of the user to the Internet and
manages the agent purchase service for the merchandise sold by said seller on the web page of said seller to which said user connects via Internet.

25. A server according to claim 21 which:
comprises Internet server function to connect said terminal of the user to the Internet and
manages the agent purchase service for the merchandise sold by said seller on the web page of said seller to which said user connects via Internet and
said request acceptance means
accepts the specification of said seller by specification of the Internet web page address.

26. A server according to claim 21 which:
comprises Internet server function to connect said terminal of the user to the Internet and
manages the agent purchase service for the merchandise sold by said seller on the web page of said seller to which the user connects via Internet and
said charge management means
charges and manages the fee of the agent purchase service of said user together with the Internet connection service fee.

27. A computer readable memory containing the transaction management program for the agent purchase service via communication lines wherein
the transaction management program for the agent purchase service comprises
a request acceptance step which, by receiving from the user terminal the specification of the purchased merchandise and the specification of the seller selling said merchandise via communication lines as the supplier of said merchandise, accepts the request for agent purchase;
a recording step to refer to or update the credit level information about each of said sellers selling the merchandise via communication lines,
a judgment step to determine whether or not to execute the requested agent purchase based on the credit level record of said seller and
a charging management step to manage charging for the agent purchase service provided to said user.

28. A computer readable memory containing the transaction management program for the agent purchase service according to claim 27 wherein:
the transaction management program for the agent purchase service further comprises:
a purchase step to execute the purchase procedures where said merchandise requested for agent purchase is purchased from said specified seller via communication lines according to the request contents received from said user.

29. A computer readable memory containing the transaction management program for the agent purchase service according to claim 27 wherein:
the transaction management program for the agent purchase service comprises:
a purchase step to execute the purchase procedures where said merchandise requested for agent purchase is purchased from said specified seller via communication lines according to the request contents received from said user, and
a delivery step where the delivery destination of the user who requested the agent purchase of the merchandise is recorded for each of said merchandises and the merchandise transporter is instructed to deliver the merchandise purchased from said seller with specification of the destination.

30. A computer readable memory containing the transaction management program for the agent purchase service according to claim 27 wherein:
the transaction management program for the agent purchase service
provides the Internet connection service to said terminal of each user and
manages the agent purchase service for the merchandise sold by said seller on the web page of said seller to which said user connects via Internet.

31. A computer readable memory containing the transaction management program for the agent purchase service according to claim 27 wherein:
the transaction management program for the agent purchase service
provides the Internet connection service to said terminal of each user and
manages the agent purchase service for the merchandise sold by said seller on the web page of said seller to which said user connects via Internet and
said request acceptance step
accepts the specification of said seller by specification of the Internet web page address.

32. A computer readable memory containing the transaction management program for the agent purchase service according to claim 27 wherein:
the transaction management program for the agent purchase service
provides the Internet connection service to said terminal of each user and
manages the agent purchase service for the merchandise sold by said seller on the web page of said seller to which said user connects via Internet and
said charge management step
charges and manages the fee of the agent purchase service of said user together with the Internet connection service fee.

33. A computer readable memory containing the transaction management program for the agent purchase service according to claim 27 wherein:
the transaction management program for the agent purchase service
provides the Internet connection service to said terminal of each user and
manages the agent purchase service for the merchandise sold by said seller on the web page of said seller to which said user connects via Internet and
said request acceptance step
accepts the specification of said seller by specification of the Internet web page address and
said charge management step
charges and manages the fee of the agent purchase service of said user together with the Internet connection service fee.
